(19) United States
(12) Patent Application Publication
(10) Pub. No.: US 2010/0181169 A1
(43) Pub. Date: Jul. 22, 2010

(54) GUIDE HOLDER FOR CONVEYOR

(76) Inventors: Zmaj Petrovic, Octeville S/Mer (FR); David Perrin, Octeville S/Mer (FR)

Correspondence Address: SUGHRUE MION, PLLC, 2100 PENNSYLVANIA AVENUE, N.W., SUITE 800, WASHINGTON, DC, 20037, US

(21) Appl. No.: 12/669,668

(22) PCT Filed: Jul. 1, 2008
(86) PCT No.: PCT/FR2008/051218

§ 371 Date: Jan. 19, 2010

(30) Foreign Application Priority Data
Jul. 20, 2007 (FR) 0705242

(51) Int. Cl. B65G 21/20

(52) U.S. Cl. 198/836.1

(57) ABSTRACT

The invention relates to a guide holder (2) in the form of a unitary piece shaped from a cylindrical bar. The holder (2) includes two portions: an L-shaped portion in the form of a flat having a branch defining the foot (5); and a cylindrical portion or rod (4) on which can slide an adjustable linking system between said holder (2) and said guide.

This invention relates to an improvement to the guide holders that can be found on conveyors and in particular the part of this holder that is fixed on the structure of the conveyor.

In a conveying installation, the guides and guide holders represent a substantial portion of the equipment. These are multiples parts that are positioned along the conveyors or conveyor tables, on each side.

The assembly time for all of this equipment is relatively long and it is above all the precision of this assembling and the adjusting of the position of the guides which gives the installation its effectiveness, i.e. an operation without incidents on products, such as bottles, which are put into circulation by the conveyor.

U.S. Pat. No. 3,776,350 and FR 2203758 show guide holders which procure several possibilities for adjusting the guide:—an adjustment in height and also—a possibility for adjustment in the transversal direction. However, this capacity of adjustment comes from a holder which is comprised of several parts.

For the holder described in aforementioned U.S. Pat. No. 3,776,350, there is a first part in the form of a right angle of which one branch is fixed on the structure of the conveyor and a second part in the form of a vertical rod which is fixed by means of a third part on the other branch of said first part and this fastening is accomplished by the intermediary of a fourth part in the form of a spring.

For the holder described in aforementioned FR 2203758, the holder comprises a first part fixed on the structure of the conveyor and a second part comprised of a cylindrical rod shaped in the form of a bayonet which is fixed on the first by means of a third part comprised of a screw.

These holders comprised of a large number of parts are relatively expensive and require much care during their assembling on the structure of the conveyor.

DE 3204114 shows a holder which is comprised of a simple flat, shaped in the form of a bayonet, of which the foot is fixed directly on the structure of the conveyor.

This holder, relatively simple in its form and inexpensive, does not provide many possibilities for adjusting the guide.

This invention propose a holder which is simple as well as universal in that it is provided with capacities for adjusting in height and in rotation for the intermediary part arranged between said holder and the guide. This holder can easily be adapted and is suitable for all situations of assembling guides on a conveyor device, i.e. allow for the assembling of curved guides, arched guides in order to create deviations in flow, etc.

In certain cases, the guides of the conveyor are arranged rather far from their holders, overhanging. This constraint imposes the use of highly resistant holders, capable of withstanding particularly high stress.

With their many parts, the holders described in aforementioned U.S. Pat. No. 3,776,350 and FR 2203758, do not have enough rigidity to accept substantial overhang and offer precision that is acceptable for the positioning of the guides.

The holder according to the invention is comprised of a single unitary part, of which the general appearance is in the form of a bayonet, holder which is shaped from a cylindrical bar, by means of a heat stamping operation, and it comprises two portions, of which the sections are different:
an upper cylindrical portion, or rod, allowing for the assembling and the adjusting of the additional means cooperating with the guide, and
a turned L portion, having at least one substantially plane face, arranged more preferably in the shape of a flat, this L comprising a branch parallel to said cylindrical rod which comprises the foot and of which the fastening is accomplished directly on the structure of the conveyor, and the other branch comprises a bend which carries out the lateral offset of said rod in such a way as to provide space in order to position said guide outside of the useful conveying surface, for example.

This holder according to the invention has the advantage of being able to be installed right from manufacture and the assembling of the elements that comprise the conveyor, i.e. it can, as in the case of the conveyor described in FR 2882738, be assembled directly with the structural elements of the frame of said conveyor.

This holder has in fact a universal nature and it makes it possible to reconcile a simple fastening system on the structure of the conveyor with interesting capacities for adjustment.

According to a preferred arrangement of the invention, the holder is shaped from a cylindrical part made of stainless steel of which the diameter is of a magnitude of 16 mm, of the round type obtained by drawing.

Still according to the invention, the junction zone between the flat and the cylindrical rod comprises at least a mark doubling as a reference, mark which is, for example, in the form of flats arranged symmetrically, flats being arranged on the junction between the two portions of the holder and they are located, for example, at a predefined distance from the upper end of the cylindrical portion in such a way as to allow for a precise and above all even adjustment of the position of the means of linkage which are interposed between said cylindrical rod and the guide during the installation of the latter, this adjustment being carried out, for example, with a wedge which is interposed between said means of linkage and said flats.

According to another arrangement of the invention, the foot and the cylindrical rod of the holder are parallel with an angular tolerance which makes it possible to have a slight inclination, towards the exterior of the conveyor, of said cylindrical rod, i.e. that the angle between the foot and the cylindrical rod can, while still remaining within the tolerances, tend to separate the upper end from said rod in relation to said foot, inclination which makes it possible to absorb the deformations of the holder that are likely to be generated by the substantial overhang of the guide.

Still according to the invention, and in particular when the distance between the holder and the guide is a constant, the additional means of linkage interposed between the two is comprised of a unitary part made from thermoplastic material doubling as a spacer, part which comprises an open sleeve which can slide on the rod of said holder and a lug which is arranged at a right angle, at the end of an arm fastened to said sleeve, lug which is arranged in order to be fixed on said guide.

According to another arrangement of the invention, the spacer comprises a lug which has a surface in the form of a cup in order to cooperate with the guide and in particular with the rib arranged protruding on the back of the rail which comprises said guide.

But the invention shall be further detailed using the following description and the annexed drawings, provided for the purposes of information, and wherein:

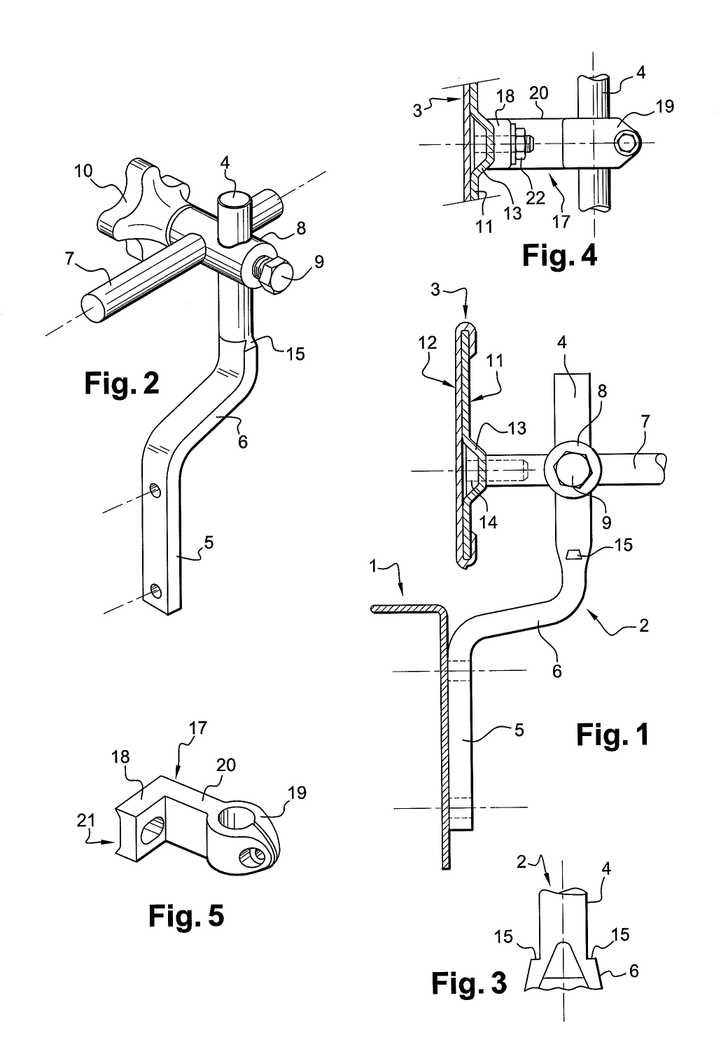

FIG. 1 shows, in the form of an elevational section, a guiding device installed on the structure of a conveyor, comprising a holder according to the invention,

FIG. 2 shows, in perspective, the holder according to the invention provided with means, partially shown, which form the link between said holder and the guide, the latter not being shown in this figure,

FIG. 3 shows, in a more detailed manner, the arrangements in the form of flats which are arranged between the two portions of the holder,

FIG. 4 is an alternative embodiment of the additional means of linkage which are interposed between the holder and the guide, for conveyors of which the guide has a fixed transversal position,

FIG. 5 is a perspective view of the additional part shown in FIG. 4, part which doubles as a spacer, providing the link between the holder and the guide.

As shown FIG. 1, the guiding device is installed laterally, on the structure 1 of a conveyor or other.

This guiding device comprises:
a part which doubles as a holder 2 properly speaking, holder 2 which is fixed to the structure 1 by suitable means which can themselves be used in the assembly of said structure, as shown in aforementioned FR 2882738,
a guide 3 properly speaking,
a means of linkage between said holder 2 and said guide 3, which doubles as a spacer, and which can, according to the case, be adjustable or fixed.

The holder 2 is comprised of a single unitary part, made of metal of a suitable material, more preferably a stainless steel material.

This holder 2 is shaped from a cylindrical bar which can be solid or hollow. More preferably, this holder 2 is made using a bar cut in a drawn circle, of stainless steel, of a diameter of a magnitude of 16 mm, and this bar is shaped via heat stamping operation.

It has the aspect of a bayonet with two distinct portions of which the sections are different:
an upper portion which has retained its cylindrical shape and which shall be qualified as a rod 4 in the remainder of the text,
a lower portion in the form of a right angle or turned L, having at least one substantially plane face, L which is, more preferably, like a flat, with a substantially rectangular section, and it comprises a foot 5, which is directly fixed on the structure 1 of the conveyor, and a bend 6 which makes the junction between said foot 5 and said rod 4.

The bend 6 forms an obtuse angle with, on one side, the foot 5 and, on the other side, with the rod 4.

The length of the bend 6 makes it possible to offset the rod 4 in relation to foot 5 and to leave enough room to house the guide 3 which, in many cases, does not encroach on the conveyor.

In order to provide great precision in positioning the guide 3, the rod 4 and the foot 5 of the holder 2 are provided to be parallel one in relation the other. However, an angular tolerance is acceptable with, in particular, an angle which allows for a slight inclination of the rod 4 towards the exterior of the conveyor, which is an advantage, when the guide 3 is relatively far from said holder 2, with substantial overhang, to compensate for the bending of said holder 2.

This holder 2 can also be carried out with a material which makes it possible to adjust the position of the rod 4 on site if required, by simple torsion and modification of the angle(s) at the end of the bend 6.

The holder 2 can be fixed directly on the structure 1 of the conveyor, on, for example, the assembly members of said structure 1, as detailed in aforementioned FR 2882737. The holders 2 are installed when assembled and the assembling of the conveyor; they are delivered with the latter.

The guide 3 is borne by a means of linkage which is comprised, in a first embodiment shown in FIGS. 1 and 2:—of a cylindrical bar 7, for example, and—of a wharve 8 which is slipped on the rod 4 of the holder 2, wharve 8 which receives said bar 7 which is arranged at a right angle in relation to said rod 4.

The wharve 8 can be adjusted in height and in orientation on the rod 4; it locks on the rod 4 via a screw 9.

Also note in FIG. 1 that the bar 7 can be adjusted in relation to the wharve 8 and it is immobilized on the latter via a screw 10 or other.

The guide 3 is comprised of two parts:
a rail 11 in the form of a metal strip which corresponds to the rigid and resistant portion of the guide and,
a section 12 which covers said rail and which doubles as a friction surface.

This section 12 is made from thermoplastic material, obtained via suitable means of the extrusion type, for example.

The rail 11 is made from a thin sheet and it comprises a rigidification rib 13 which provides it with a certain inertia.

This rib 13 also makes it possible to house the head of the screw 14 which is used for the fastening of the guide 3 on the end of the bar 7. This arrangement makes it possible to have a sliding surface, for the guide 3, without any asperities, which prevents any retaining of waste, dirt or other, likely to contaminate the products transported by the conveyor.

The fastening of the guide 3 can also be carried out by the intermediary of a yoke, not shown, said yoke being fixed in the same manner, discreetly by bolts of which the head is countersunk in the rib 13. The assembling of the guide 3 with a yoke provides more possibilities for adjustment and flexibility for its installation on the holder 2.

The positioning of the guide 3 in relation to the conveyor is made easier by means of an arrangement made on the holder 2. This holder 2 comprises, between the rod 4 and the bend 6, marks which are in the form of flats 15, as shown in FIG. 3.

These flats 15 are arranged symmetrically on either side of the holder 2, under the level of the cylindrical rod 4, at the location where the sections of the holder 2 change, where the round portion which corresponds to the rod 4 switches to the portion in the shape of a flat which comprises the bend 6 and the foot 5.

In order to level and adjust the guide 3, the operator can use a wedge, or pin gauge, not shown. This wedge is then interposed between the flat(s) 15 and the means of linkage, here the wharve 8 in FIGS. 1 and 2.

The level of the flats 15 is, for example, adjusted in relation to the upper end of the rod 4 and this upper end is itself positioned with a distance that is measured from the fastening points of the foot 5 on the structure 1 of the conveyor.

FIG. 4 shows an alternative embodiment of the linkage system between the holder 2 and the guide 3, in the case of a conveyor wherein the transversal position of said guide 3 does not need to be adjusted, position which is fixed and pre-established.

The guide 3 is borne by a spacer 17 which has the form of a unitary part, part which can, for example, be made from thermoplastic material.

The spacer 17 comprises, as shown also in FIG. 5, a lug 18 which is fixed to the rail 11 of the guide 3 and a sleeve 19 which can slide on the rod 4 of the holder 2 with, between the two, an arm 20 which is at a right angle in relation to the lug 18.

The sleeve 19 is of the cleft type and its position can be adjusted on the rod 4 in height and in orientation.

The lug 18 comprises a surface which makes it possible to ensure its linkage with the guide 3. This linkage surface is in the form of a cup 21 in order to hug the rib 13 of the rail 11 and the fastening of this lug 18, with said rail 11, is carried out as before, with a bolt 22 of which the head is countersunk in said rib 13.

In the two cases shown in the figures, note that the rod 4 of the holder 2 makes it possible to adjust the height of the means of linkage between said holder 2 and the guide 3 but also to adjust the angular orientation of these means of linkage, means which can be oriented at will, concerning the wharve 8 or the spacer 17.

1-6. (canceled)

7. A guide holder for a conveyor, comprised of a single unitary part, of which the general appearance is in the form of a bayonet, wherein said holder is shaped from a cylindrical bar and comprises two portions of which the sections are different, and which portions are:
an upper portion, in the form of a cylindrical rod, allowing for the assembling and the adjusting in height and in rotation of additional means cooperating with the guide, and
a turned L portion, having at least one substantially plane face, said L portion comprising a branch parallel to said cylindrical rod, branch which forms a foot and the fastening of said foot is carried out directly on a structure of the conveyor, and an other branch of said L portion comprises a bend which carried out a lateral offset of said rod.

8. The guide holder according to claim 7, which is shaped via a heat stamping operation using a cylindrical part made of stainless steel of which the diameter is of a magnitude of 16 mm, of the round type obtained by drawing.

9. The guide holder according to claim 7 comprising, on a junction zone between said bend and said rod, at least one mark doubling as a reference, mark which is comprised of flats arranged symmetrically.

10. The guide holder according to claim 7, wherein said foot and said rod are parallel one in relation to the other with an angular tolerance which makes it possible to have a slight inclination of said rod towards the exterior of the conveyor.

11. The guide holder according to claim 7, wherein a linkage system with guide is comprised of a unitary part made from thermoplastic material doubling as a spacer, part which comprises an open sleeve which can slide on said rod and a lug which is fixed on said guide.

12. The guide holder according to claim 11, wherein said spacer comprises a lug which has a surface in the form of a cup in order to cooperate with the guide.

13. A guide holder according to claim 7, wherein said plane face of said turned L portion is arranged in the shape of a flat.

14. A guide holder according to claim 7, wherein said lateral offset of said rod is in such a way as to provide space in order to position said guide outside of a useful conveying surface.

15. A guide holder according to claim 9, wherein said flats are located, at a predefined distance from an upper end of said rod.

16. A guide holder according to claim 12, wherein said cup cooperates with a rib of said rail which comprises said guide.
